(19) United States
(12) Patent Application Publication
(10) Pub. No.: US 2006/0085501 A1
(43) Pub. Date: Apr. 20, 2006

(54) Mediation system for browsing Internet applications and non-Internet applications

(75) Inventors: Laurent Delorme, Arcueil (FR); Sandra Le Moing, Linas (FR); Thierry Pernot, Saint Germain Les Corbeil (FR); Jean Rojnic, Antony (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/244,047

(22) Filed: Oct. 6, 2005

(30) Foreign Application Priority Data
Oct. 20, 2004 (FR) 0411179

(51) Int. Cl. G06F 15/16

(52) U.S. Cl. 709/203

(57) ABSTRACT

A system is dedicated to mediating between Internet applications accessible by a web browser installed in a communication equipment connected to an Internet Protocol communication network and non-Internet applications accessible by at least one secondary browser installed in the communication equipment. The system comprises mediation means adapted, each time that a user activates an Internet first application by means of a web browser and then sends this first application an interaction message in the format of the Internet browser and including data representing a non-Internet second application and at least one operation to be effected on that second application: i) to determine a non-Internet browser adapted to the second application, ii) to convert data in the received interaction message and representing at least one operation to be effected on the second application into converted activation data comprehensible to the non-Internet browser, and iii) to contact the non-Internet browser that has been determined so that it accesses the second application to effect thereon each operation represented by the converted data.

### CROSS-REFERENCE TO RELATED APPLICATIONS

This application is based on French Patent Application No. 0411179 filed Oct. 20, 2004, the disclosure of which is hereby incorporated by reference thereto in its entirety, and the priority of which is hereby claimed under 35 U.S.C. §119.

### BACKGROUND OF THE INVENTION

1. Field of the Invention

The invention concerns the field of communication networks, and more precisely interaction within such networks between Internet applications and non-Internet applications.

In the present context, the expression “Internet application” refers to a software application that is accessible and executable by means of a web browser installed in a communication equipment and may be installed in that communication equipment or in a remote communication equipment. Moreover, in the present context, the expression “non-Internet application” refers to a software application accessible by means of a non-Internet browser compatible with a given operating system (OS), such as Alcatel NAV® or Microsoft OLE®, for example, or any tool employing specific mechanisms equivalent to those offered by an operating system and executable by means of the corresponding operating system. Additionally, in the present context, the expression “communication equipment” refers to any user equipment that is capable of exchanging data with a communication network to which it is coupled (or connected). It may therefore be a fixed or mobile telephone, a desktop or laptop computer, a personal digital assistant (PDA) or a server, provided that it is equipped with a communication function.

2. Description of the Prior Art

The man skilled in the art knows that non-Internet software applications are generally defined by means of a programming language of C++ or Java type whereas Internet software applications are generally defined by means of HyperText Markup Language (HTML) type pages or small programs (also known as “applets” or Java Web Start applications, and generally written in the Java language) that are executed by means of a web browser.

Many software applications, such as certain network management applications, for example, are non-Internet applications, whereas most new software applications are implemented in the Internet technology. Now, these applications of different types are increasingly required to work (or interact) together.

For example, in a network management environment there exist applications dedicated to the visualization of network elements and others dedicated to the detection of alarms relating to said network elements. To be able to visualize a network element that originates an alarm, and where applicable to transmit specific parameters to that network element, the visualization and detection applications concerned must be made to interact, which necessitates setting up a “bridge” between them. Now, if these applications are of different types (which is generally the case), setting up a bridge in this way necessitates a plurality of operations on each of the applications, which operations are sometimes complex, and in particular activation by the user of the visualization application outside the environment of the detection application. This is a result of the fact that these applications are accessed by means of browsers of different types.

Thus an object of the invention is to remedy some or all of the drawbacks cited above.

### SUMMARY OF THE INVENTION

To this end, the invention proposes a system for mediating between Internet applications accessible by a web browser installed in a communication user equipment (such as a computer, for example) connected to an Internet Protocol (IP) communication network and non-Internet applications accessible by at least one non-Internet browser installed in the communication user equipment.

This mediation system is distinguished by the fact that it comprises mediation means that intervene each time that a user activates an Internet first application by means of a first web browser installed in the user (communication) equipment in which they are themselves partially installed and then sends the Internet first application an interaction message in the format of the web browser and including data representing a non-Internet second application and at least one operation to be effected on that non-Internet second application. To be more precise, the mediation means are adapted: i) to determine a non-Internet browser adapted to the second application, ii) to convert data in the received interaction message in the format of the web browser and representing at least one operation to be effected on the non-Internet second application into converted activation data comprehensible to the non-Internet browser that has been determined, and iii) to contact the non-Internet browser that has been determined so that it accesses the non-Internet second application to effect thereon each operation represented by the converted data.

The mediation system of the invention may have complementary other features that may be used separately or in combination, and in particular:
the operation to be effected may consist in activating the associated application and/or sending at least one message to the associated application,
its mediation means may comprise first mediation means installed in an Internet server and adapted in the event of activation of an Internet application by means of a web browser to access a first memory, optionally installed in the Internet server, storing a first table establishing the correspondences between data representing Internet applications and/or non-Internet applications and data representing addresses at which it is possible to access the applications and browsers to be used to access the applications, so as to determine the non-Internet browser associated with the non-Internet application designated in the received interaction message, and to send an information message including at least data representing the address of the non-Internet application and the non-Internet browser adapted thereto,
its mediation means may comprise second mediation means (downloaded from an Internet server or installed in the user's communication equipment) adapted in the event of reception of an information message coming from the first mediation means to access a second memory, optionally installed in the communication user equipment, storing a second table (or an algorithm) establishing the correspondences between data representing the non-Internet browsers and data representing data conversion modules, so as: i) to determine
the conversion module corresponding to the non-Internet browser represented by certain of the data contained in the received information message, ii) then to supply that conversion module with certain of the data contained in the received interaction message in order for it to convert it into data comprehensible to the non-Internet browser that has been determined, and iii) to contact the non-Internet browser that has been determined in order for it to access the non-Internet second application at the address represented by the data contained in the received information message and effect on that non-Internet second application each associated operation represented by the converted data,
the data conversion modules may be installed in the second mediation means,
at least one of the non-Internet applications may be installed in the communication equipment or in another communication equipment connected to the communication equipment including the second mediation means.

The invention also proposes communication equipment for an Internet Protocol (IP) communication network, comprising second mediation means of a mediation system of the type defined hereinabove.

The invention further proposes an Internet server for an Internet network, comprising first mediation means of a mediation system of the type defined hereinabove.

Other features and advantages of the invention will become apparent on reading the following detailed description and examining the appended drawings.

### BRIEF DESCRIPTION OF THE DRAWINGS

FIG. 1 is a diagram of one example of the coupling between a communication network and the Internet via a mediation system of the invention.

FIG. 2 is a diagram of one embodiment of an Internet server of the invention coupled to one embodiment of a communication equipment of the invention between which the first and second mediation modules of one embodiment of a mediation system of the invention are divided.

FIG. 3 is a diagram of one example of an algorithmic diagram of mediation between an Internet application and a non-Internet application.

### DETAILED DESCRIPTION OF THE PREFERRED EMBODIMENT

The appended drawings constitute part of the description of the invention as well as contributing to the definition of the invention, if necessary.

An object of the invention is to enable interaction between Internet applications and non-Internet applications.

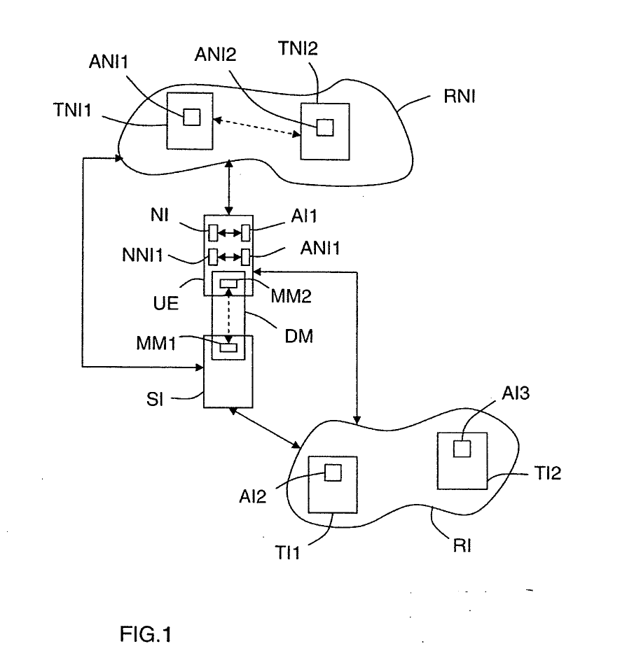

FIG. 1 is referred to first to introduce the invention.

As indicated in the introductory part, in the field of communication networks two worlds coexist and interact: the so-called “Internet” world, consisting of the world-wide Internet RI, and the so-called “non-Internet” world, consisting of a set RNI of communication networks, for example Internet Protocol (IP) networks, connected to the Internet RI and to each other by gateways providing the router function.

Communication user equipments UE are generally connected to the non-Internet world and/or to the Internet world.

In the present context, the expression “communication equipment UE” refers to any user equipment capable of exchanging data with a communication network to which it is coupled (or connected). It can therefore be a fixed or mobile telephone, a desktop or laptop computer, a personal digital assistant (PDA) or a server, provided that it is equipped with a communication function.

To access the world of the Internet RI, a user equipment UE must include a web browser NI for accessing and activating (or executing) Internet applications AIi installed in said equipment UE or in terminals TIj of the Internet RI. In the nonlimiting example shown, the value of the suffix i is from 1 to 3 and the value of the suffix j is 1 or 2. However, the suffixes i and j can take any value greater than zero (0). Moreover, a user equipment UE or a terminal Tj may include a plurality of Internet applications AI. The web browser NI is Microsoft Internet Explorer®, for example.

Furthermore, a user equipment UE generally includes at least one non-Internet browser NNI1 for accessing and activating (or executing) at least one non-Internet application ANI1, installed in said equipment UE or in terminals TNIk of a communication network RNI to which it is coupled (where applicable via one or more other communication networks RNI). In the nonlimiting example shown, the value of the suffix k is 1 or 2. However, the suffix k can take any value. The non-Internet browsers NNI are Alcatel NAV® and Microsoft OLE®, for example. Generally speaking, the expression “non-Internet browser” refers either to a browser compatible with an operating system (OS) or a tool employing specific browsing mechanisms executable by means of a given operating system.

The invention proposes a mediation system DM that enables a user equipment UE to have an Internet application AI interact with at least one non-Internet application ANI.

The mediation system DM is more specifically responsible for determining a non-Internet browser suitable for a non-Internet second application each time that a user activates an Internet first application by means of a web browser installed in his user equipment UE and then communicates to that first Internet application an interaction message in the web browser format and including data representative of a non-Internet second application and at least one operation to be effected on that non-Internet second application.

The mediation system DM is thereafter responsible for converting data in the web browser format contained in the interaction message received that represents at least one operation to be effected on the non-Internet second application into converted activation data comprehensible to the non-Internet browser determined in this way.

In the present context, the term “operation” refers to any action relative to an Internet application AI or a non-Internet application ANI, such as activating (or executing) an application or sending one or more messages to an application, for example, where applicable following activation (or execution).

Finally, the mediation system DM is adapted to contact the non-Internet browser that has been determined in order for it to access the non-Internet second application in order to effect thereon each operation represented by the converted data.

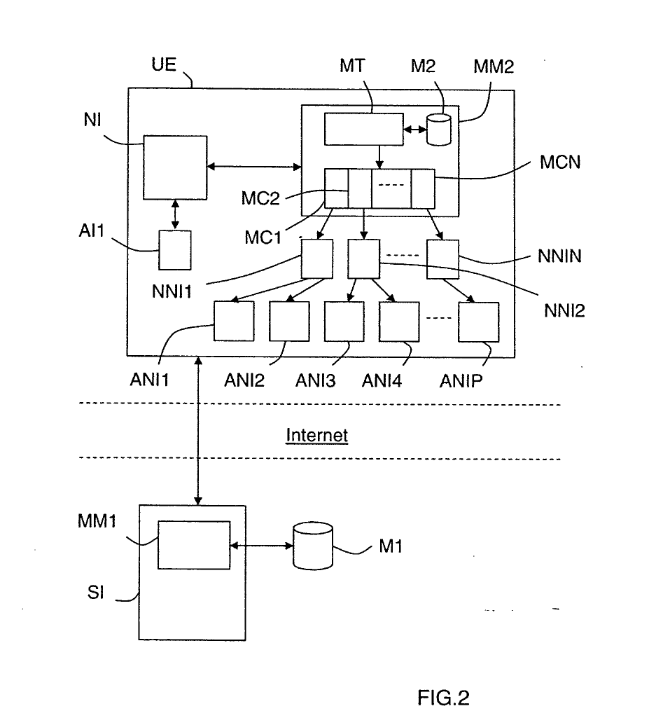

As shown better in FIG. 2, the mediation system DM preferably consists of first and second mediation modules MM1 and MM2 that collaborate, preferably within a client/server type architecture.

The first mediation module MM1 is installed in an Internet server SI (belonging to the Internet RI, for example) and the second mediation module MM2 is downloaded from the same Internet server SI (or where applicable from a server different from that containing the first mediation module MM1) or installed in each user equipment UE implementing the invention.

The first mediation module MM1 intervenes each time that an Internet first application AI has been activated by the user of an equipment UE and it has received an interaction message from the latter by means of the associated web browser NI installed in that user equipment UE.

The user uses the (associated) web browser NI to activate an Internet first application, for example the application AI1.

When the Internet first application AI1 receives from the user via the web browser NI installed in a user equipment UE an interaction message designating a non-Internet second application, for example the application ANI2, it sends the web browser NI the data contained in that interaction message that at least represents the non-Internet second application ANI2 and each operation to be effected thereon, so that it forwards the data to the first mediation module MM1.

The first mediation module MM1 then accesses a first memory M1 in which is stored a first table establishing the correspondences between data representing Internet applications AI and/or non-Internet applications ANI, data representing addresses at which those applications can be accessed and data representing secondary browsers NNI to be used to access those applications.

This first memory M1, which forms part of the mediation system DM, may be installed in the Internet server SI. This is not obligatory, however. It may be installed in another Internet server or terminal TI of the Internet RI provided that it is accessible to the Internet server SI in which the first mediation module MM1 is installed.

The first mediation module MM1 determines in the first correspondence table the non-Internet browser, for example the browser NNI1, that is stored in corresponding relationship to the non-Internet second application (here the application ANI2 designated by the received interaction data and the address of that second application ANI2. It then sends its Internet server SI an information message (or mediation request) including data representing the address of the non-Internet second application ANI2 to be activated and the non-Internet browser NNI1 suitable therefor for it to forward this information message to the user equipment UE concerned.

On receiving the information message the user equipment UE forwards it to its second mediation module MM2. The second mediation module MM2 includes, for example, a processing module MT adapted to access a second memory M2 in which is stored a second table (or an algorithm) establishing the correspondences between data representing the non-Internet browsers NNIn and data representing data conversion modules MCn. In the nonlimiting example shown, the value of the index n is from 1 to N.

Each conversion module MCn is associated with a single non-Internet browser NNIn and adapted to convert data that it receives in the format of the web browser NI into data comprehensible by the non-Internet browser NNIn. Each conversion module MCn is preferably also responsible for converting data that it receives in the format of a non-Internet browser NNIn into data comprehensible by the Internet browser NI.

Moreover, each non-Internet browser NNIn is associated with at least one non-Internet application ANIp. In the nonlimiting example shown, the value of the suffix p is from 1 to P.

It is important to note that N can be different from P, in other words that the number of non-Internet browsers NNIn may be less than the number of non-Internet applications ANIp. Accordingly, in the present nonlimiting example, the first non-Internet browser NNI1 is associated with first and second non-Internet applications ANI1 and ANI2, the second non-Internet browser NNI2 is associated with third and fourth non-Internet applications ANI3 and ANI4 and the Nth non-Internet browser NNIN is associated with a Pth non-Internet application ANIP.

The second memory M2 may be installed in the second mediation module MM2, as shown. This is not obligatory, however. It could be installed in each user equipment UE, or even in an external server, and coupled to the second mediation module MM2. Moreover, the data conversion modules MCn may be installed in the second mediation module MM2, as shown. This is not obligatory, however. They could be installed in each user equipment UE, or even in an external server, and coupled to the second mediation module MM2.

Once the processing module MT of the second mediation module MM2 has determined in the second correspondence table (or the correspondence algorithm) the conversion module, here the module MC1, that corresponds to the non-Internet browser NNI1 represented by certain of the data contained in the received information message, it supplies this conversion module, here the module MC1, in order for it to convert at least the data representing the operations to be effected (contained in the received interaction message) into converted data comprehensible to the non-Internet browser NNI1.

The processing module MT then requests the non-Internet browser NNI1 to access the non-Internet second application ANI2 represented by the received interaction data and communicates the converted data to it. The non-Internet browser NNI2 then accesses the non-Internet second application ANI2 at the address contained in the received information message in order to effect thereon each associated operation represented by the converted data.

If the non-Internet second application ANI has not yet been activated, the corresponding non-Internet browser NNI must first load it (or execute it) before it can send it the data or commands (or instructions) initially supplied in the form of interaction data by the user of the equipment UE.

For example, if the Internet first application AI is dedicated to detecting alarms relating to network elements and the non-Internet second application ANI is dedicated to visualizing data and/or pictures on the screen of a user equipment UE, interaction between these two applications, instigated by the mediation system DM, enables the visualization on said screen of a network element and a precise list of the alarms present at that network element.

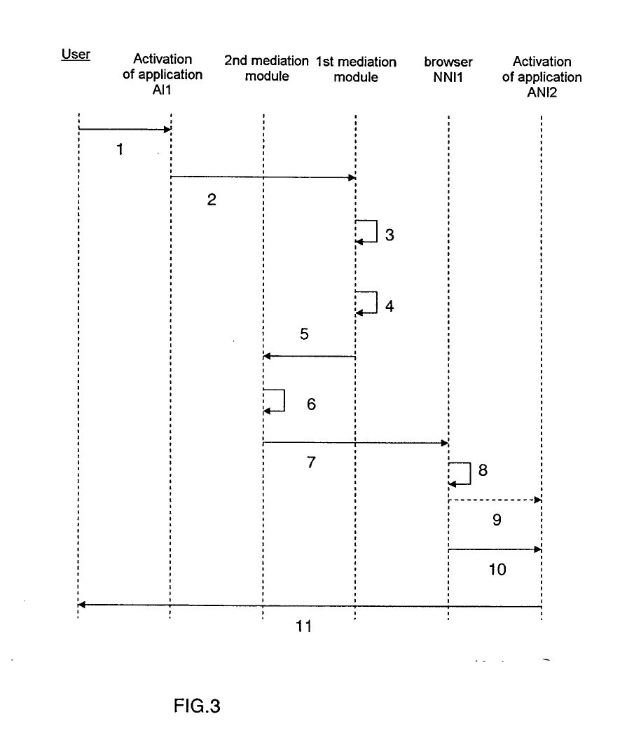

The various steps executed by the mediation system DM to enable interaction between two applications are summarized in the example of an algorithm shown in the FIG. 3 diagram.

To be more precise, in a first step 1 the user of the equipment UE activates (or loads) an Internet first application, for example the application AI1, by means of the corresponding Internet browser NI and sends it an interaction message designating a non-Internet second application, for example the application ANI2, which it wishes to have interact with the Internet application AI1 and including data representing at least one operation that must be effected on that non-Internet application ANI2.

In a second step 2 the Internet first application AI1 supplies to the Internet browser NI the data contained in the interaction message that at least represents the non-Internet second application ANI2 and each operation to be effected thereon, so that it forwards the data to the first mediation module MM1.

In a third step 3 the first mediation module MM1 determines in the first memory M1 the non-Internet browser NNI1 corresponding to the non-Internet application ANI2 and the address thereof.

In a fourth step 4 the first mediation module MM1 generates an information message (or mediation request) containing at least the identifier of the non-Internet browser NNI1 and the address of the non-Internet second application ANI2.

In a fifth step 5 the first mediation module MM1 has the information message sent to the second mediation module MM2.

In a sixth step 6 the second mediation module MM2 determines the conversion module MC1 corresponding to the non-Internet browser NNI1 and then sends it the activation data (previously received from the user equipment UE) representing the operations to be effected in order for it to convert it to the format of said non-Internet browser NNI1.

In a seventh step 7 the second mediation module MM2 sends the non-Internet browser NNI1 designated in the received information message the data converted by the conversion module MC1 and the address of the non-Internet second application ANI2.

In an eighth step 8 the non-Internet browser NNI1 verifies if the non-Internet second application ANI2 has been activated (or loaded) previously.

If this is not the case, in a ninth step 9 the non-Internet browser NNI1 accesses the non-Internet second application ANI2 at the address received in order to load it and therefore to activate it.

Then, or if the non-Internet second application ANI2 has not been activated (or loaded) previously, in a tenth step 10 the non-Internet browser NNI1 effects each operation requested by the user. This may entail sending a message containing data and/or instructions, for example.

Finally, in an eleventh step 11 the non-Internet second application ANI2 displays the result of the operation effected (this entails using the visualization non-Internet second application ANI2 to display on the screen of the user equipment UE a network element that is the subject of an alarm detected in the Internet first application AI1, for example).

In the embodiments described above, the Internet and non-Internet applications are all installed in the user equipment supplying the interaction messages. This is not obligatory, however. At least one of the Internet applications accessible by the Internet browser installed in the user equipment and/or at least one of the non-Internet applications accessible by one of the non-Internet browsers installed in the user equipment may be installed in remote equipments or terminals coupled (or connected) to said user equipment.

Moreover, in the example shown in FIGS. 1 and 2, the second mediation module MM2 of the mediation system DM is downloaded from a server into each user equipment UE. However, as indicated above, it may be envisaged that the mediation module MM2 be installed in the user equipment UE.

The mediation system DM of the invention, and in particular its first and second mediation modules MM1 and MM2, may be implemented in the form of electronic circuits, software (or data processing) modules or a combination of circuits and software. Accordingly, all or part of the first mediation module may take the form of small programs in the Java language of the “applet” or Java web start type. The Java language is particularly beneficial in that many different operating systems support it.

Thanks to the invention it is now possible to browse the Internet world and the non-Internet world, regardless of the protocol used to access an Internet or non-Internet application, and transparently, as much for the user as for the applications concerned.

The invention is not limited to the mediation system, communication equipment and Internet server embodiments described above by way of example only, but encompasses all variants that the person skilled in the art might envisage that fall within the scope of the following claims.

1. A system for mediating between Internet applications accessible by a web browser installed in a communication user equipment connected to an Internet Protocol communication network and non-Internet applications accessible by at least one non-Internet browser installed in said communication user equipment, which system comprises mediation means adapted, each time that a user activates an Internet first application by means of an Internet browser installed in said user equipment and then sends said Internet first application an interaction message in the format of said Internet browser and including data representing a non-Internet second application and at least one operation to be effected on that non-Internet second application: i) to determine a non-Internet browser adapted to said non-Internet second application, ii) to convert data in said received interaction message in the format of said web browser and representing at least one operation to be effected on said non-Internet second application into converted activation data comprehensible to said non-Internet browser that has been determined, and iii) to contact the non-Internet browser that has been determined so that it accesses said non-Internet second application to effect thereon each operation represented by said converted data.

2. The system according to claim 1, wherein said operation to be effected comprises activating said associated non-Internet second application.

3. The system according to claim 1, wherein said operation to be effected comprises sending at least one message to said associated application.

4. The system according to claim 1, wherein said mediation means comprise first mediation means installed in an Internet server and adapted in the event of activation of an Internet first application by means of a web browser to access a first memory storing a first table establishing the correspondences between data representing Internet applications and/or non-Internet applications and data representing addresses at which it is possible to access said applications and browsers to be used to access said applications, so as to determine said non-Internet browser associated with said non-Internet second application designated in said received interaction message, and to send an information message including at least data representing the address of said non-Internet second application and said non-Internet browser adapted thereto.

5. The system according to claim 4, wherein said first memory is installed in said Internet server.

6. The system according to claim 4, wherein said mediation means comprise second mediation means adapted in the event of reception of an information message coming from said first mediation means to access a second memory storing a second table establishing the correspondences between data representing said non-Internet browsers and data representing data conversion modules, so as: i) to determine the conversion module corresponding to the non-Internet browser represented by certain of the data contained in said received information message, ii) then to supply that conversion module with certain of the data contained in said received interaction message in order for it to convert it into data comprehensible to said non-Internet browser that has been determined, and iii) to contact said non-Internet browser that has been determined in order for it to access said non-Internet second application at the address represented by said data contained in said received information message and effect on that non-Internet second application each associated operation represented by said converted data.

7. The system according to claim 6, wherein said second mediation means are downloaded from an Internet server into said communication equipment.

8. The system according to claim 6, wherein said second mediation means are installed in said communication equipment.

9. The system according to claim 6, wherein said second memory is installed in said communication equipment.

10. The system according to claim 6, wherein said second mediation means comprise said data conversion module.

11. The system according to claim 1, wherein at least one of said non-Internet applications is installed in said communication equipment.

12. The system according to claim 1, wherein at least one of said non-Internet applications is installed in another communication equipment connected to said communication equipment including said second mediation means.

13. Communication equipment for an Internet Protocol communication network, comprising second mediation means of a mediation system according to claim 1.

14. An Internet server for an Internet network, comprising first mediation means of a mediation system according to claim 1.
